(19) United States
(12) Patent Application Publication
(10) Pub. No.: US 2026/0074877 A1
(43) Pub. Date: Mar. 12, 2026

(54) Clock syntonization using digital control loop

(71) Applicant: Mellanox Technologies, Ltd., Yokneam (IL)

(72) Inventors: Natan Manevich, Nesher (IL); Bar Shapira, Tel Aviv (IL); Nir Laufer, Zoran (IL); Dotan Levi, Kiryat Motzkin (IL); Ana-Maria Cretan, Bucharest (RO); Asaf Horev, Rishon Lezion (IL); Guy Lederman, Ness Ziona (IL); Yuri Chipchev, Rishon Lezion (IL); Dmitry Lachover, Holon (IL)

(21) Appl. No.: 18/882,798

(22) Filed: Sep. 12, 2024

(51) Int. Cl. H04L 7/00; H04J 3/06; H04L 7/033

(52) U.S. Cl. CPC H04L 7/0008; H04J 3/0638; H04L 7/033

(57) ABSTRACT

In one embodiment, a syntonization system includes a device including a dedicated clock signal input interface to be connected by a clock connection to a remote device and to receive a remote clock signal from the remote device, the remote device being external to the device, and clock circuitry to generate a local clock signal, and a digital clock controller to generate digital control signals to control the clock circuitry to syntonize the local clock signal according to the remote clock signal based on a difference between frequencies of the remote clock signal and the local clock signal, and provide the digital control signals to the clock circuitry, wherein the clock circuitry is to adjust the frequency of the local clock signal based on the digital control signals.

### FIELD OF THE DISCLOSURE

The present disclosure relates to computer systems, and in particular, but not exclusively to, clock syntonization.

### BACKGROUND

Clock synchronization among network devices is used in many network applications. One application of using a synchronized clock value is for measuring one-way latency from one device to another device. If the clocks are not synchronized the resulting one-way latency measurement will be inaccurate.

Synchronization is typically achieved by syntonization, in which the clock frequency of two devices is aligned, and aligning the phase between the two devices.

For Ethernet, there are two complementary methods to achieve synchronization. One is Synchronous Ethernet (SyncE), which is a physical-layer protocol which achieves syntonization based on the receive/transmit symbol rate. SyncE is an International Telecommunication Union Telecommunication (ITU-T) Standardization Sector standard for computer networking that facilitates the transference of clock signals over the Ethernet physical layer. In particular, SyncE enables clock syntonization inside a network with respect to a master clock.

The other is Precision Time Protocol (PTP), which is a packet-based protocol that may be used with SyncE to align offset (e.g., in Coordinated Universal Time (UTC) format) and phase between two clocks. It should be noted that PTP may be used alone over Ethernet (without SyncE), but this is typically used for lower accuracy use cases. PTP is used to synchronize clocks throughout a computer network, and is considered to be the de facto standard for this purpose.

Time, clock, and frequency synchronization are crucial in some modern computer network applications. They enable 5G and 6G networks, and are proven to enhance the performance of data center workloads.

### OVERVIEW

There is provided in accordance with an embodiment of the present disclosure, a syntonization system, including a device including a dedicated clock signal input interface to be connected by a clock connection to a remote device and to receive a remote clock signal from the remote device, the remote device being external to the device, and clock circuitry to generate a local clock signal, and a digital clock controller to generate digital control signals to control the clock circuitry to syntonize the local clock signal the remote clock signal based on a difference between frequencies of the remote clock signal and the local clock signal, and provide the digital control signals to the clock circuitry, wherein the clock circuitry is to adjust the frequency of the local clock signal based on the digital control signals.

Further in accordance with an embodiment of the present disclosure the device includes a high-speed interconnect ASIC, which includes the dedicated clock signal input interface.

Still further, in accordance with an embodiment of the present disclosure the digital clock controller is disposed on the high-speed interconnect ASIC.

Additionally in accordance with an embodiment of the present disclosure the digital clock controller is to execute firmware to generate the digital control signals to control the clock circuitry, and provide the digital control signals to the clock circuitry.

Moreover, in accordance with an embodiment of the present disclosure the digital clock controller is disposed in a host device which executes software to generate the digital control signals to control the clock circuitry, and provide the digital control signals to the clock circuitry.

Further in accordance with an embodiment of the present disclosure the device includes at least one counter to count clock signal pulses of the remote clock signal and the local clock signal, and the digital clock controller is to generate the digital control signals based on at least one value of the at least one counter.

Still further in accordance with an embodiment of the present disclosure the remote clock signal is received by the dedicated clock signal input interface from the remote device as an analog signal, and the dedicated clock signal input interface includes an analog to digital converter to convert the remote clock signal from an analog signal to a digital signal.

Additionally in accordance with an embodiment of the present disclosure the device includes a counter to count a difference between clock signal pulses of the remote clock signal and clock signal pulses of the local clock signal, and the digital clock controller is to generate the digital control signals based on at least one value of the counter.

Moreover, in accordance with an embodiment of the present disclosure the digital clock controller is to generate the digital control signals in order to maintain the counter at a given value, which represents the local clock signal and the remote clock signal having a same frequency.

Further in accordance with an embodiment of the present disclosure the device includes a first counter to count clock signal pulses of the remote clock signal, the device includes a second counter to count clock signal pulses of the local clock signal, and the digital clock controller is to generate the digital control signals based on at least one value of the first counter and at least one value of the second counter.

Still further in accordance with an embodiment of the present disclosure the digital clock controller is to generate the digital control signals in order to maintain the first counter and the second counter at respective values that represent syntonization of the local clock signal and the remote clock signal.

Additionally in accordance with an embodiment of the present disclosure the clock circuitry includes signal generation circuitry to generate a reference clock signal, and the clock circuitry also includes frequency manipulation circuitry to generate the local clock signal from the reference clock signal, the local clock signal and the reference clock signal having different frequencies.

Moreover, in accordance with an embodiment of the present disclosure the device includes ports, and the frequency manipulation circuitry is to generate a network clock signal to drive the ports from the reference clock signal or from the local clock signal, the network clock signal and the local clock signal having different frequencies.

Further in accordance with an embodiment of the present disclosure the device includes a circuit board including a high-speed interconnect ASIC, and the signal generation circuitry is disposed on the circuit board externally to the high-speed interconnect ASIC.

Still further in accordance with an embodiment of the present disclosure the frequency manipulation circuitry is disposed on the high-speed interconnect ASIC.

Additionally in accordance with an embodiment of the present disclosure the frequency manipulation circuitry includes at least one phase locked loop (PLL) circuit.

Moreover, in accordance with an embodiment of the present disclosure the signal generation circuitry includes any one or more of the following a digitally controlled oscillator, a network synchronizer, or a digital phase locked loop (DPLL) circuit.

Further in accordance with an embodiment of the present disclosure the device is a syntonization leader device.

Still further in accordance with an embodiment of the present disclosure the remote device is a non-network device and includes a clock output port.

Additionally in accordance with an embodiment of the present disclosure the remote device includes any one or more of the following a Global Navigation Satellite Systems (GNSS) receiver, an atomic clock, or a Precision Time Protocol (PTP) grand master.

Moreover, in accordance with an embodiment of the present disclosure, the system includes a circuit board, wherein the device is disposed on the circuit board and includes a high-speed interconnect ASIC, and the remote device is disposed on the circuit board externally to the high-speed interconnect ASIC.

There is also provided in accordance with another embodiment of the present disclosure a syntonization method, including receiving a remote clock signal from a remote device via a clock connection using a dedicated clock input interface, generating a local clock signal, generating digital control signals to control clock circuitry to syntonize the local clock signal the remote clock signal based on a difference between frequencies of the remote clock signal and the local clock signal, providing the digital control signals to the clock circuitry, and adjusting the frequency of the local clock signal based on the digital control signals.

### BRIEF DESCRIPTION OF THE DRAWINGS

The present disclosure will be understood from the following detailed description, taken in conjunction with the drawings in which:

FIG. 1 is a block diagram view of a clock syntonization system constructed and operative in accordance with an embodiment of the present disclosure;

FIG. 2 is a flowchart including steps in a syntonization method for use with the system of FIG. 1;

FIG. 3 is a block diagram view of signal generation circuitry of a device of the system of FIG. 1;

FIG. 4 is a block diagram view of a remote device in the system of FIG. 1; and

FIG. 5 is a block diagram of a clock syntonization system constructed and operative in accordance with an alternative embodiment of the present disclosure.

### DESCRIPTION OF EXAMPLE EMBODIMENTS

### Overview of Example Embodiments

As previously mentioned, SyncE is a physical-layer protocol which achieves syntonization based on the receive/transmit symbol rate and facilitates the transference of clock signals over the Ethernet physical layer. Syntonization of a local clock to a remote clock connected by a high-speed interconnect (e.g., Ethernet or PCIe) may be performed by counting symbols received versus symbols transmitted and adjusting the local clock based on the difference between the symbols received and the symbols transmitted. In some environments, syntonization may be desired with a device which is not connected, or connectable, over a network connection.

Embodiments of the present disclosure address at least some of the above drawbacks, by providing a system including a network device (or any suitable device such as a high-speed interconnect device including a central processing unit (CPU) and/or graphics processing unit (GPU)) having a dedicated clock signal input interface connected by a clock connection to a remote device which provides a remote clock signal via the clock connection to the network device. The remote clock signal generated by the remote device is indicative of the frequency of the clock of the remote device. The network device includes one or more counters to count clock pulses of the received remote clock signal and clock pulses of a local clock signal generated by the network device. The counter(s) are read intermittently by a digital clock controller (e.g., by a firmware processor, or by hardware, or by software running on a central processing unit), which processes the read counter value(s) and issues one or more digital control commands to clock circuitry to adjust the local clock so as to syntonize the local clock to the remote clock.

In some embodiments, a digital phase-locked loop (DPLL) mechanism installed on a circuit board of the network device feeds a device ASIC (e.g., a high-speed interconnect ASIC) with a reference clock signal. The reference clock signal may be processed (e.g., by frequency manipulation circuitry such as one or more PLLs of the device ASIC) to provide the local clock signal and a network clock signal, which drives Serializer-Deserializer logic (SerDes) of network ports of the network device. The local clock signal and the network clock signal are proportional to the reference clock signal, and any changes made to the reference clock signal follow through to the local clock signal and the network clock signal. The local clock signal may also drive a dedicated clock signal output interface, which can then be used for further syntonization to one or more other devices, or for monitoring purposes. In some embodiments, the local clock signal and the clock signal provided to the dedicated clock signal output interface may have different frequencies that are proportional to the reference clock generated by the DPLL.

As mentioned above, the digital clock controller intermittently reads the counter(s) that count clock pulses of the remote clock signal and the local clock signal, processes the read counter value(s), and issues one or more digital control commands to clock circuitry to adjust the local clock so as to syntonize the local clock to the remote clock based on maintaining the counts of the pulses of the remote clock signal and the local clock signal equal in the long term. In some embodiments, the digital clock controller provides the digital control commands to the DPLL to adjust the reference clock signal which results in syntonization of all the clock signals (e.g., the local and network clock signal) which originate from, and are proportional to, the reference clock signal.

For example, assuming that the remote clock signal is based on a 10-megahertz (MHz) nominal clock, the local clock signal may also be generated as a 10 MHz signal, and counters count the pulses of the local clock signal and the remote clock signal. The digital clock controller periodically samples the clock counters, and tries to equalize the values of the counters by adjusting the clock frequency generated by the DPLL, which leads to adjustment of the local clock signal thereby leading to syntonization of the local clock signal to the remote clock signal and correct adjustment of the network clock signal.

Assuming both counters start counting from 0, if the digital clock controller detects that the value of the counter (“local clock counter”) counting pulses of the local clock signal is less than the value of the counter (“remote clock counter”) counting pulses of the remote clock signal, it provides one or more digital control commands (e.g., frequency adjustment command(s)) to the DPLL to speed up the clock frequency, and vice-versa.

In some embodiments, a single counter may be used to count both pulses of the local clock signal and the remote clock signal. For example, pulses of the local clock signal cause the counter to increment, and pulses of the remote clock signal cause the counter to decrement, or vice-versa. The digital clock controller may try to maintain the counter at a constant value, such as zero.

The control loop mechanism can be implemented in different ways, such as in firmware, software, or fully in hardware. When implemented in software, internal states (such as the state of the counters or the difference between the counters) from the hardware may be exposed to the software.

In some embodiments, filtering mechanisms may be used to filter out possible noise in the remote clock signal, for example, if a sudden frequency spike is detected. In some embodiments, the DPLL functionality may be part of another device, such as a network synchronizer or a digitally controlled oscillator (DCO). When the reference clock signal generated by the DPLL also feeds the ports and SerDes, the clock frequency can be further transferred over a highspeed interconnect to link partners of the network device. For example, when the highspeed interconnect is implemented using Ethernet, the frequency may be distributed using SyncE over the network. The above enables building scalable SyncE switches, without needing to use clock in and clock out connections of a network synchronizer device.

Even when syntonized, the frequencies of the local clock signal and the remote clock signal are not necessarily the same. The device may syntonize the local clock signal to the remote clock signal based on a known ratio between the frequencies of the local clock signal and the remote clock signal. For example, if the remote clock signal has a nominal frequency of 10 MHz and the local clock signal has a “nominal” or base frequency of 20 MHz, the digital clock controller may generate the digital control signals to the DPLL based on maintaining the local clock counter to be twice the value of the remote clock counter, at any given time. In some embodiments, the local clock counter may be configured to count every other clock pulse, and the remote clock counter may be configured to count every clock pulse. In some embodiments, the network device is mounted on the circuit board and includes a high-speed interconnect ASIC, and the remote device is mounted on the circuit board externally to the high-speed interconnect ASIC.

### System Description

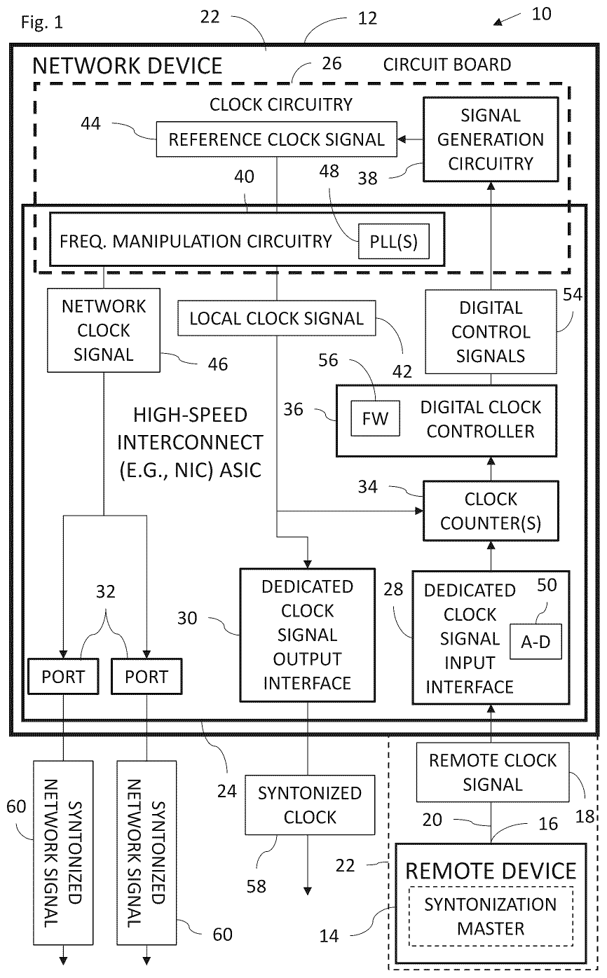

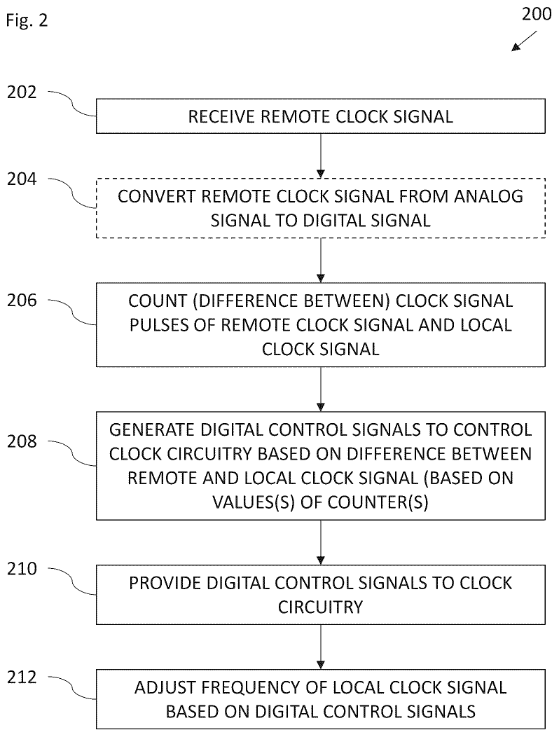

Reference is now made to FIGS. 1 and 2. FIG. 1 is a block diagram view of a clock syntonization system 10 constructed and operative in accordance with an embodiment of the present disclosure. FIG. 2 is a flowchart 200 including steps in a syntonization method for use with the system 10 of FIG. 1. The system 10 includes a network device 12 and a remote device 14.

The remote device 14 includes a clock output port 16. In some embodiments, the remote device 14 is a non-network device. The remote device 14 is configured to generate and output a remote clock signal 18 from the clock output port 16 via a clock connection 20 to the network device 12.

The network device 12 includes a circuit board 22 and a high-speed interconnect application-specific integrated circuit (ASIC) 24 disposed on the circuit board. A high-speed interconnect ASIC is an ASIC which embeds a clock value (e.g., the frequency of a clock maintained by the ASIC) in data transmitted by the ASIC. In the example of FIG. 1, high-speed interconnect ASIC 24 is a network interface controller (NIC) ASIC. In some embodiments, the high-speed interconnect ASIC 24 may implement functionality of a network switch, or a data processing unit (DPU) and/or include a data communication bus (e.g., Peripheral Component Interconnect Express (PCIe)) interface. Examples of high-speed interconnect standards include PCIe, Ethernet, InfiniBand, and NV Link.

The network device 12 includes clock circuitry 26, a dedicated clock signal input interface 28, a dedicated clock signal output interface 30, one or more network ports 32, one or more clock counters 34, and a digital clock controller 36. In some embodiments, dedicated clock signal input interface 28, dedicated clock signal output interface 30, network port(s) 32, clock counter(s) 34, and digital clock controller 36 are disposed on high-speed interconnect ASIC 24.

The clock circuitry 26 includes signal generation circuitry 38 and frequency manipulation circuitry 40. In some embodiments, frequency manipulation circuitry 40 is disposed on high-speed interconnect ASIC 24. In some embodiments, signal generation circuitry 38 is disposed on the circuit board 22 externally to the high-speed interconnect ASIC 24. The clock circuitry 26 is configured to generate a local clock signal 42 as described in more detail below.

The signal generation circuitry 38 is configured to generate a reference clock signal 44 (e.g., having any suitable frequency, such as 100 MHz). The frequency manipulation circuitry 40 is configured to generate the local clock signal 42 (e.g., having any suitable frequency, such as 500 MHz) from the reference clock signal 44. The local clock signal 42 and the reference clock signal 44 have different frequencies. The frequency manipulation circuitry 40 is configured to generate a network clock signal 46 (e.g., having any suitable frequency, such as 156.25 MHz) from the reference clock signal 44 or from the local clock signal 42 to drive the ports 32. The network clock signal 46 and the local clock signal 42 typically have different frequencies. In some embodiments, the frequency manipulation circuitry 40 includes at least one phase locked loop (PLL) circuit 48. Although the frequencies of the reference clock signal 44, local clock signal 42, and the network clock signal 46 are generally different, the frequencies have a fixed relationship with each other (i.e., the frequencies are proportional to each other) with the local clock signal 42 and network clock signal 46 being derived from the reference clock signal 44.

The dedicated clock signal input interface 28 is configured to be connected by clock connection 20 to remote device 14 and to receive remote clock signal 18 from remote device 14 (block 202). The remote device 14 is external to network device 12. The dedicated clock signal input interface 28 is dedicated for clock signals only, i.e., not for network signals or packets where the symbol rates represent the frequency of the clock signal. In some embodiments, the remote clock signal 18 is received by the dedicated clock signal input interface 28 from the remote device 14 as an analog signal and the dedicated clock signal input interface 28 includes an analog to digital converter 50 to convert the remote clock signal 18 from an analog signal to a digital signal (block 204).

In some embodiments, clock counter(s) 34 are configured to count clock signal pulses of the remote clock signal 18 and the local clock signal 42 (block 206).

In some embodiments, the device includes one counter 34 configured to count a difference between clock signal pulses of the remote clock signal 18 and clock signal pulses of the local clock signal 42. For example, pulses of the local clock signal 42 cause the counter 34 to increment, and pulses of the remote clock signal 18 cause the counter 34 to decrement, or vice-versa. The digital clock controller 36 may try to maintain the counter 34 at a constant value, such as zero or 100 or any suitable value. For example, the network device 12 may operate until the value of the clock counter 34 reaches 100, and then the digital clock controller 36 tries to maintain the value of clock counter 34 as close to 100 as possible.

In some embodiments, one counter 34 (“remote clock counter”) is configured to count clock signal pulses of the remote clock signal 18, and another counter 34 (“local clock counter”) is configured to count clock signal pulses of the local clock signal 42.

Whether a single clock counter 34 is used to count the clock signal pulses of the remote clock signal 18 and local clock signal 42, or different counters 34 are used to count the remote clock signal 18 and local clock signal 42, the clock counter(s) 34 may be configured to count a multiple or a fraction of the received remote clock pulses for remote clock signal 18 and/or local clock signal 42. For example, the local clock counter may be configured to count every tenth pulse of a 10 MHz signal.

If the local clock signal 42 and the remote clock signal 18 have different “base” or nominal frequencies, the clock counter(s) 34 may be configured to count the pulses of the remote clock signal 18 and the local clock signal 42 differently (e.g., counting every X^{th} pulse of the remote clock signal 18 while counting every pulse of the local clock signal 42) and/or the digital clock controller 36 is configured to treat the counter values differently (i.e., by multiplying the values up or down, as appropriate).

The digital clock controller 36 is configured to generate digital control signals 54 to control the signal generation circuitry 38 of clock circuitry 26 to syntonize the local clock signal 42 according to the remote clock signal 18 based on a difference between frequencies of the remote clock signal 18 and the local clock signal 42 (block 208). In some embodiments, the local clock signal 42 and the remote clock signal 18 have different “base” or nominal frequencies, but the local clock signal 42 is changed by the signal generation circuitry 38 under control of the digital clock controller 36 so that the frequency of the local clock signal 42 is maintained at a fixed proportional relationship with the frequency of remote clock signal 18.

In some embodiments, the digital clock controller 36 is configured to generate the digital control signals 54 based on the value(s) of the clock counter(s) 34. When a single counter 34 is used to count the pulses of the local clock signal 42 and the remote clock signal 18, the digital clock controller 36 is configured to generate the digital control signals 54 based on the value(s) of the single counter 34. In some embodiments, the digital clock controller 36 is configured to generate the digital control signals 54 in order to maintain the counter at a given value (e.g., any constant value), which represents the local clock signal 42 and the remote clock signal 18 having a same frequency or a fixed proportional relationship between the frequency of the remote clock signal 18 and local clock signal 42.

In embodiments where one counter 34 (“remote clock counter”) is configured to count clock signal pulses of the remote clock signal 18, and another counter 34 (“local clock counter”) is configured to count clock signal pulses of the local clock signal 42, the digital clock controller 36 is configured to generate the digital control signals 54 based on one or more values of the remote clock counter and one or more values of the local clock counter. In some embodiments, the digital clock controller 36 is configured to generate the digital control signals 54 in order to maintain the local clock counter and the remote clock counter at respective values that represent syntonization of the local clock signal and the remote clock signal (even if the base frequency of the remote clock signal 18 and the local clock signal 42 are different). For example, if the local clock signal 42 has a base frequency of 100 MHz and the remote clock signal 18 has a base frequency of 10 MHz, the digital clock controller 36 is configured to maintain 100 million counts of pulses of local clock signal 42 for every 10 million pulses of the remote clock signal 18.

The digital clock controller is configured to provide the digital control signals 54 to the signal generation circuitry 38 of clock circuitry 26 (block 210). In some embodiments, the digital clock controller 36 is configured to execute firmware 56 configured to: generate the digital control signals 56 to control the signal generation circuitry 38 of clock circuitry 26; and provide the digital control signals 56 to signal generation circuitry 38 of the clock circuitry 26.

The signal generation circuitry 38 of clock circuitry 26 is configured to adjust the frequency of the local clock signal 42 based on the digital control signals 56 (block 212). The network device 12 may be configured to be a syntonization leader device providing a syntonized clock signal 58 to other devices via the dedicated clock signal output interface 30 or syntonized network signals 60 over a network via network port(s) 32.

In practice, some or all of the functions of digital clock controller 36 may be combined in a single physical component or, alternatively, implemented using multiple physical components. These physical components may comprise hard-wired or programmable devices, or a combination of the two. In some embodiments, at least some of the functions of digital clock controller 36 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

In some embodiments, the network device 12 is disposed on the circuit board 22 and includes high-speed interconnect ASIC 24, and the remote device 14 is disposed on the circuit board 22 externally to the high-speed interconnect ASIC 24.

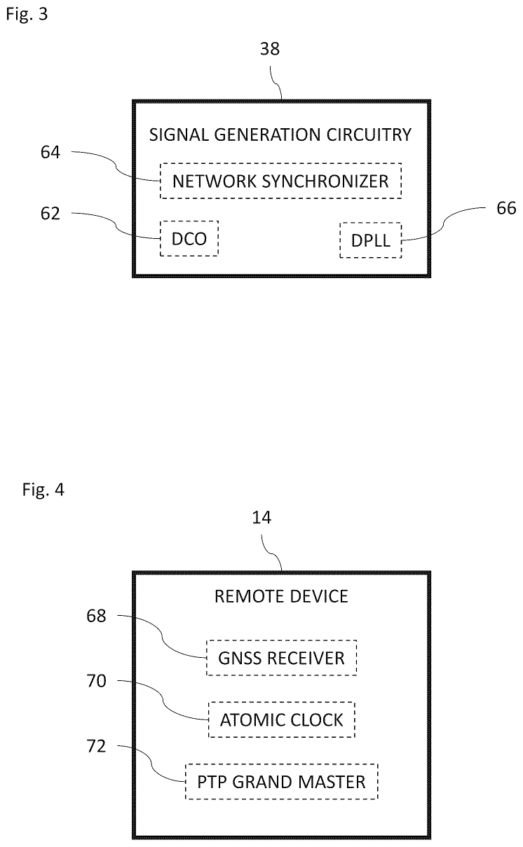

Reference is now made to FIG. 3, which is a block diagram view of signal generation circuitry 38 of device 12 of the system 10 of FIG. 1. In some embodiments, signal generation circuitry 38 may include any one or more of the following: a digitally controlled oscillator (DCO) 62; a network synchronizer 64; and/or a digital phase locked loop (DPLL) circuit 66. The network synchronizer 64 may be any suitable network synchronizer such as a low or ultra-low frequency jitter synchronizer. An example of a suitable network synchronizer is Ultra-Low Jitter Network Synchronizer Clock LMK05318 commercially available from Texas Instruments Inc., 12500 TI Boulevard, Dallas, Texas 75243, USA. The DCO 62 may provide a local clock signal with low phase noise and good drift stability and may be controlled by digital control signals/commands. The DCO 62 may include a temperature-compensated crystal oscillator (TCXO) and generate an output frequency of around 156.25 MHz. SiT5377 is a ±100 ppb precision MEMS Super-TCXO and is suitable for use as DCO 62. SiT5377 is commercially available from SiTime Corporation, 5451 Patrick Henry Drive, Santa Clara, CA 95054, USA.

Reference is now made to FIG. 4, which is a block diagram view of remote device 14 in the system 10 of FIG. 1. The remote device 14 may include any one or more of the following: a Global Navigation Satellite Systems (GNSS) receiver 68; an atomic clock 70; and/or a Precision Time Protocol (PTP) grand master 72.

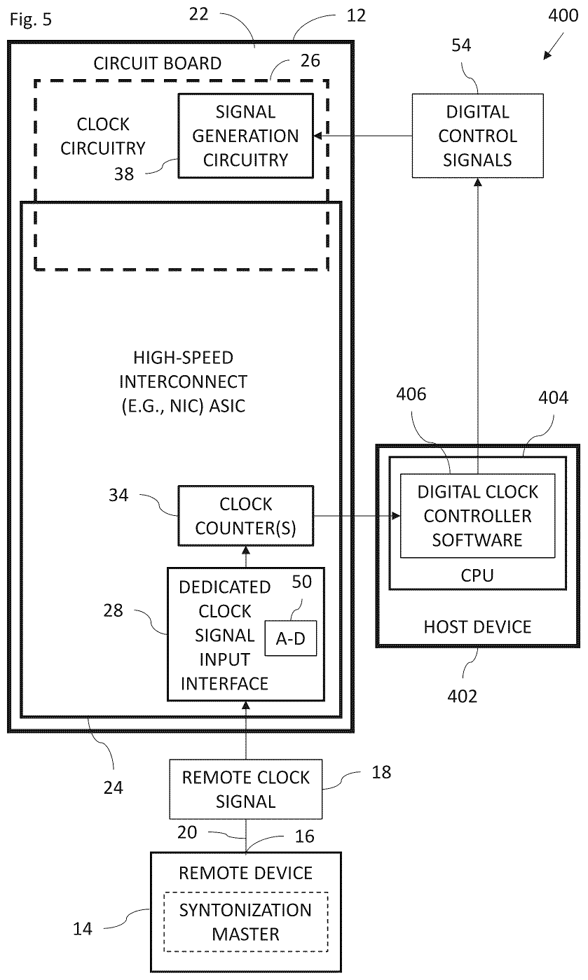

Reference is now made to FIG. 5, which is a block diagram of a clock syntonization system 400 constructed and operative in accordance with an alternative embodiment of the present disclosure. For the sake of simplicity, the network device 12 shown in FIG. 5 is only shown with some of the elements of network device 12. Network device 12 includes all of the elements of network device 12 as described with reference to FIG. 1, except for the differences described below.

The clock syntonization system 400 is substantially the same as the system 10 of FIG. 1 except that digital clock controller 36 is disposed in a host device 402 and is not disposed in network device 12. The digital clock controller 36 is disposed in host device 402 in the form of a central processing unit (CPU) 404 of host device 402 executing digital clock controller software 406. In some embodiments, the CPU 404 may be replaced by a GPU or a combined CPU/GPU. The digital clock controller software 406 is configured to intermittently read the clock counter(s) 34, use the read counter value(s) to generate digital control signals 54 to control signal generation circuitry 38 of clock circuitry 26, and provide digital control signals 54 to signal generation circuitry 38 of clock circuitry 26. In some embodiments, the digital clock controller software 406 is configured to provide digital control signals 54 to signal generation circuitry 38 of clock circuitry 26 via high-speed interconnect ASIC 24.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A syntonization system, comprising:
a device including:
a dedicated clock signal input interface to be connected by a clock connection to a remote device and to receive a remote clock signal from the remote device, the remote device being external to the device; and
clock circuitry to generate a local clock signal; and
a digital clock controller to:
generate digital control signals to control the clock circuitry to syntonize the local clock signal according to the remote clock signal based on a difference between frequencies of the remote clock signal and the local clock signal; and
provide the digital control signals to the clock circuitry, wherein the clock circuitry is to adjust the frequency of the local clock signal based on the digital control signals.

2. The system according to claim 1, wherein the device includes a high-speed interconnect ASIC, which includes the dedicated clock signal input interface.

3. The system according to claim 2, wherein the digital clock controller is disposed on the high-speed interconnect ASIC.

4. The system according to claim 2, wherein the digital clock controller is to execute firmware to: generate the digital control signals to control the clock circuitry; and provide the digital control signals to the clock circuitry.

5. The system according to claim 1, wherein the digital clock controller is disposed in a host device which executes software to generate the digital control signals to control the clock circuitry; and provide the digital control signals to the clock circuitry.

6. The system according to claim 1, wherein:
the device includes at least one counter to count clock signal pulses of the remote clock signal and the local clock signal; and
the digital clock controller is to generate the digital control signals based on at least one value of the at least one counter.

7. The system according to claim 6, wherein:
the remote clock signal is received by the dedicated clock signal input interface from the remote device as an analog signal; and
the dedicated clock signal input interface includes an analog to digital converter to convert the remote clock signal from an analog signal to a digital signal.

8. The system according to claim 1, wherein:
the device includes a counter to count a difference between clock signal pulses of the remote clock signal and clock signal pulses of the local clock signal; and
the digital clock controller is to generate the digital control signals based on at least one value of the counter.

9. The system according to claim 8, wherein the digital clock controller is to generate the digital control signals in order to maintain the counter at a given value, which represents the local clock signal and the remote clock signal having a same frequency.

10. The system according to claim 1, wherein:
the device includes a first counter to count clock signal pulses of the remote clock signal;
the device includes a second counter to count clock signal pulses of the local clock signal; and
the digital clock controller is to generate the digital control signals based on at least one value of the first counter and at least one value of the second counter.

11. The system according to claim 10, wherein the digital clock controller is to generate the digital control signals in order to maintain the first counter and the second counter at respective values that represent syntonization of the local clock signal and the remote clock signal.

12. The system according to claim 1, wherein:
the clock circuitry includes signal generation circuitry to generate a reference clock signal; and
the clock circuitry also includes frequency manipulation circuitry to generate the local clock signal from the reference clock signal, the local clock signal and the reference clock signal having different frequencies.

13. The system according to claim 12, wherein:
the device includes ports; and
the frequency manipulation circuitry is to generate a network clock signal to drive the ports from the reference clock signal or from the local clock signal, the network clock signal and the local clock signal having different frequencies.

14. The system according to claim 12, wherein:
the device includes a circuit board including a high-speed interconnect ASIC; and
the signal generation circuitry is disposed on the circuit board externally to the high-speed interconnect ASIC.

15. The system according to claim 14, wherein the frequency manipulation circuitry is disposed on the high-speed interconnect ASIC.

16. The system according to claim 15, wherein the frequency manipulation circuitry includes at least one phase locked loop (PLL) circuit.

17. The system according to claim 12, wherein the signal generation circuitry includes any one or more of the following: a digitally controlled oscillator; a network synchronizer; or a digital phase locked loop (DPLL) circuit.

18. The system according to claim 1, wherein the device is a syntonization leader device.

19. The system according to claim 1, wherein the remote device is a non-network device and includes a clock output port.

20. The system according to claim 1, wherein the remote device includes any one or more of the following: a Global Navigation Satellite Systems (GNSS) receiver; an atomic clock; or a Precision Time Protocol (PTP) grand master.

21. The system according to claim 1, further comprising a circuit board, wherein:
the device is disposed on the circuit board and includes a high-speed interconnect ASIC; and
the remote device is disposed on the circuit board externally to the high-speed interconnect ASIC.

22. A syntonization method, comprising:
receiving a remote clock signal from a remote device via a clock connection using a dedicated clock input interface;
generating a local clock signal;
generating digital control signals to control clock circuitry to syntonize the local clock signal according to the remote clock signal based on a difference between frequencies of the remote clock signal and the local clock signal;
providing the digital control signals to the clock circuitry; and
adjusting the frequency of the local clock signal based on the digital control signals.
